(19) United States
(12) Patent Application Publication
(10) Pub. No.: US 2007/0131067 A1
(43) Pub. Date: Jun. 14, 2007

(54) Tool for removing engine oil filter

(76) Inventor: Pi-Liang Wu, Taichung (TW)

Correspondence Address: PI-LIANG WU, P.O. BOX 55-124, TAICHUNG, TW

(21) Appl. No.: 11/341,389

(22) Filed: Jan. 30, 2006

(30) Foreign Application Priority Data
Dec. 8, 2005 (TW) 094219365

(51) Int. Cl. B25B 13/18

(52) U.S. Cl. 81/128

(57) ABSTRACT

A tool for removing engine oil filter includes two clamp members which are movably connected with each other and two links are respectively connected to the two clamp members. A base has a base plate and a driving head is located at a center of an underside of the base plate. The two links are respectively connected to two ends of the base plate so that when rotating the base, the two links push the two clamp members away from each other or pull the two clamp members toward each other. The two clamp members are easily to mount the engine oil filter of any size and are moved simultaneously.

### FIELD OF THE INVENTION

The present invention relates to a tool for removing engine oil filter and includes two links connected to the two clamp plates so that the two clamp plates are moved simultaneously.

### BACKGROUND OF THE INVENTION

A conventional tool for removing engine oil filter is shown in FIG. 1 and generally includes a base 1 with a driving head 301 on an underside thereof and two clamp plates 2 are movably located on the base 1. A driving mechanism 3 including gears are connected to the two clamp plates 2. Two springs 4 are connected between the two clamp plates 2 so as to keep the two clamp plates 2 to have a tendency to move toward each other. When removing the engine oil filter 9 as shown in FIG. 2, the two clamp plates 2 are pulled outward so that the engine oil filter 9 is located between the two clamp plates 2. The two clamp plates 2 are then released and clamp the engine oil filter 9. A wrench (not shown) is then engaged with the driving head 301 to rotate the base 1 to rotate the engine oil filter 9. It is noted that the two springs 4 are respectively connected between two respective ends of the two clamp plates 2 so that a limited space is defined between the springs 4 and the clamp plates 2. Therefore, when the size of the engine oil filter 9 is larger than the space, the user has to pull the springs 4 outward by his fingers to accommodate the engine oil filter 9 in the space as shown in FIG. 2. The user uses the fingers of two hands to pull the springs 4 so that it is in convenient to pull the clamp plates 2 and the springs 4 outward simultaneously. Besides, the user's fingers can be hurt during operation.

The present invention intends to provide a tool for removing the engine oil filter wherein the two clamp plates are connected with two links which are pivotably connected to the base so that the tool is easily mounted to the engine oil filter even if the filter has a larger size.

### SUMMARY OF THE INVENTION

The present invention relates to a tool for removing engine oil filter and the tool comprises a base which includes a base plate and a driving head is located at a center of an underside of the base plate. A first link has a first end pivotably connected to a first end of the base plate and a second link has a first end pivotably connected to a second end of the base plate. A first clamp member has two first extensions extending therefrom and a second end of the first link is pivotably connected to the first clamp member. A second clamp member has two second extensions extending therefrom and a second end of the second link is pivotably connected to the second clamp member. The first and second clamp members are moved toward or away from each other when rotating the base.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a conventional tool for removing engine oil filter;

FIG. 2 shows the two springs of the conventional tool for removing engine oil filter are pulled outward to accommodate an engine oil filter between the two clamp plates of the conventional tool for removing engine oil filter;

FIG. 3 is a perspective view to show the tool for removing engine oil filter of the present invention;

FIG. 4 is an exploded view to show the tool for removing engine oil filter of the present invention;

FIG. 5 shows the connection of the base plate and the two links of the tool for removing engine oil filter of the present invention;

FIG. 6 shows the connection of the first extensions and the second extensions of the tool for removing engine oil filter of the present invention;

FIG. 7 shows an engine oil filter is clamped between the clamp members of the tool for removing engine oil filter of the present invention;

FIG. 8 shows the two clamp members are moved away from each other;

FIG. 9 shows the base is rotated clockwise to move the two clamp members away from each other;

FIG. 10 shows the base is rotated counter clockwise to pull the two clamp members toward each other;

FIG. 11 is a perspective view to show another embodiment of the tool for removing engine oil filter of the present invention, and

FIG. 12 is a cross sectional view to show that a spring is connected between the two clamp members in the embodiment in FIG. 11.

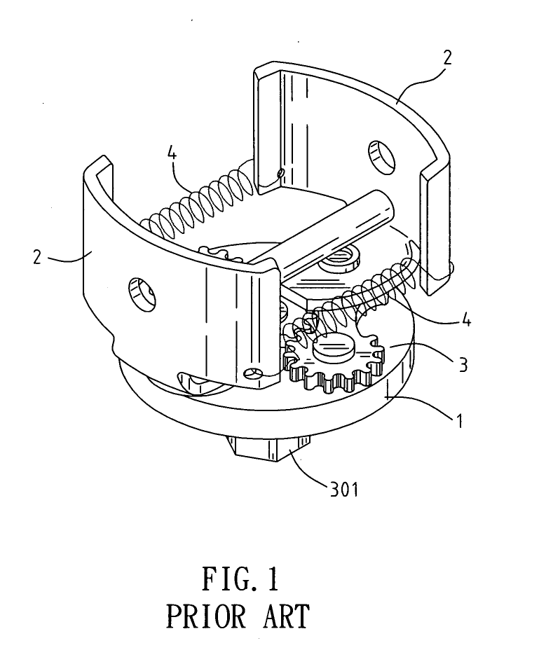

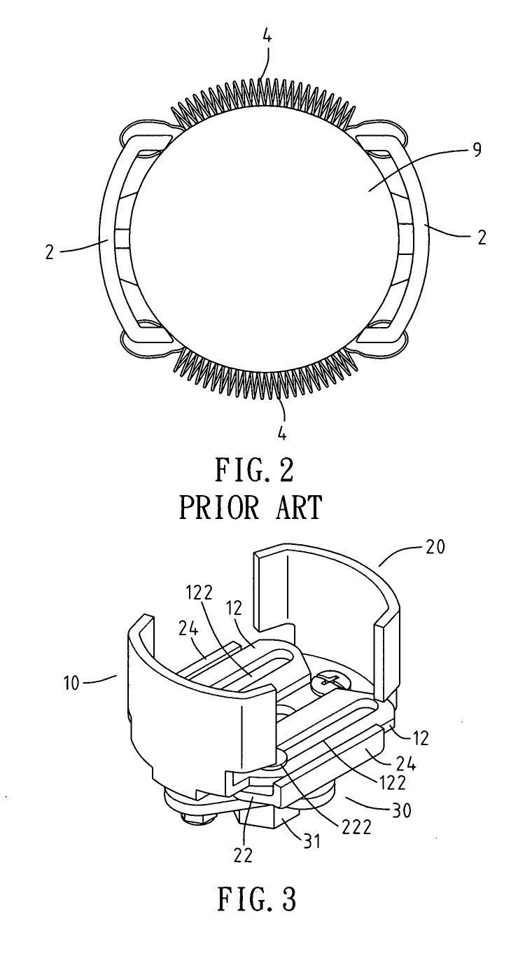

### DETAILED DESCRIPTION OF THE PREFERRED EMBODIMENT

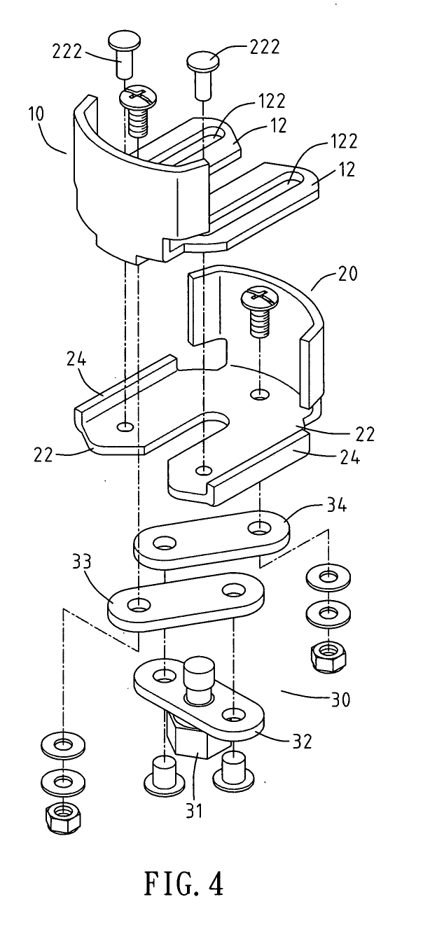

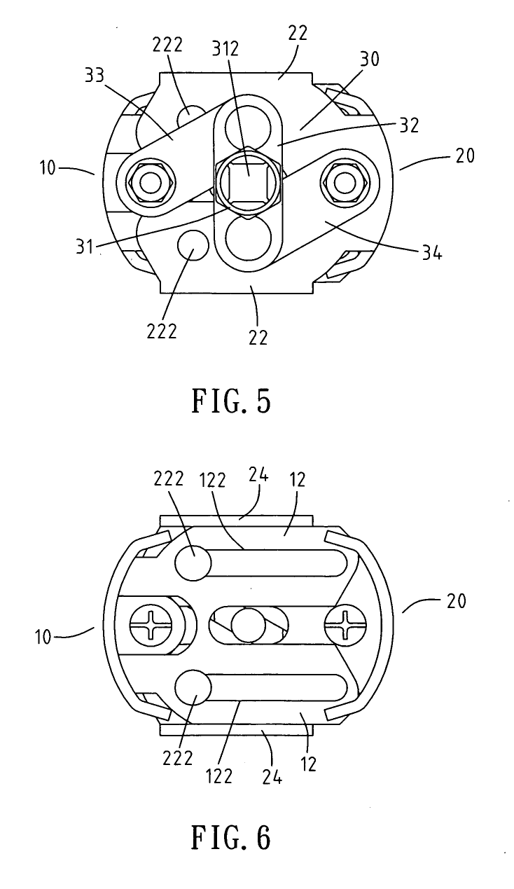

Referring to FIGS. 3 to 6, the tool for removing engine oil filter of the present invention comprises a base 30 which includes an elongate base plate 32 and a driving head 31 is located at a center of an underside of the base plate 32. The driving head 31 has a polygonal outer periphery and an engaging recess 312 is defined in an end surface of the driving head 31, so that a wrench or any known tool (not shown) can rotate the driving head 31 conveniently.

A first link 33 has a first end pivotably connected to a first end of the base plate 32 and a second link 34 has a first end pivotably connected to a second end of the base plate 32.

A first clamp member 10 has an upright plate and two parallel first extensions 12 extending from a lower end of the first clamp member 10. A second end of the first link 33 is pivotably connected to the first clamp member 10. A second clamp member 20 has an upright plate and two parallel second extensions 22 extending from a lower end of the second clamp member 20. A second end of the second link 34 pivotably connected to the second clamp member 10. The first extensions 12 each have an elongate slots 122 and two pins 222 extend through the two elongate slots 122 and are connected to the two second extensions 22. Each of the second extensions 22 has a guide wall 24 extending from a side thereof and two respective sides of the two first extensions 12 are slidable along the two guide walls 24, so that the first and second extensions 12, 22 can only be moved linearly with each other.

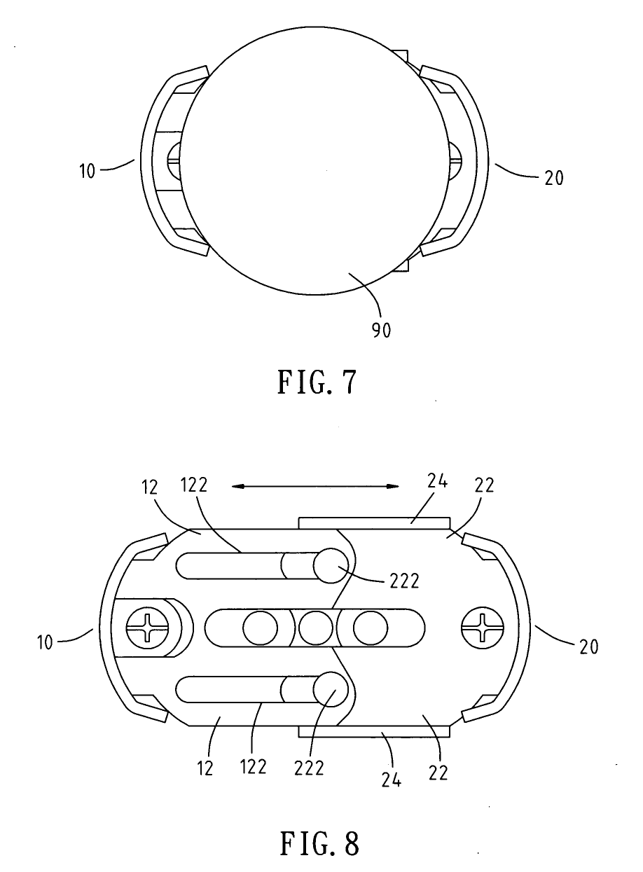

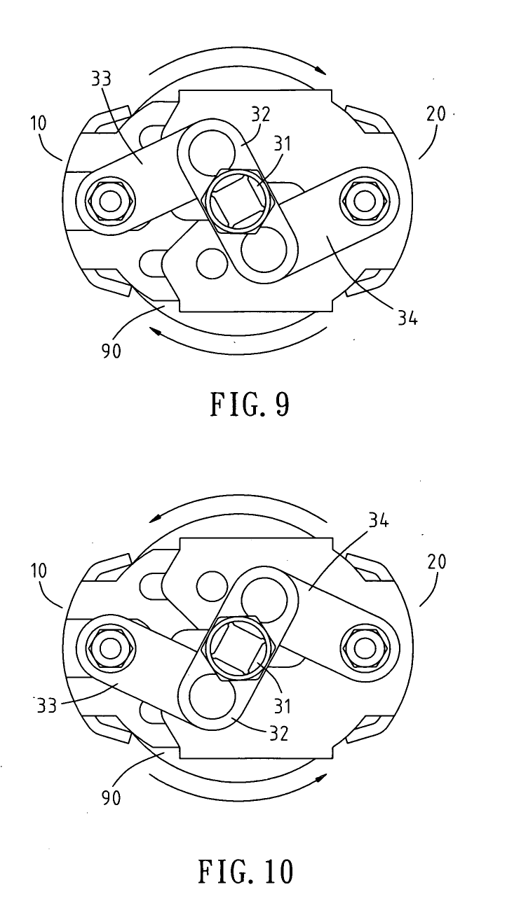

As shown in FIGS. 6 and 7, the two upright plates of the first and second clamp members 10, 20 can be easily pulled away from each so that an engine oil filter 90 is clamped between the two upright plates without interruption by springs as shown in the conventional tool for removing engine oil filter. The user uses a tool to rotate the driving head 31 clockwise as shown in FIG. 9, the first and second links 33, 34 are moved outward to move the first and second clamp members 10, 20 away from each other so that the engine oil filter 90 is easily positioned between the two upright plates. When rotating the driving head 31 counter clockwise as shown in FIG. 10, the first and second links 33, 34 are pulled toward each other to pull the first and second clamp members 10, 20 toward each other so that the engine oil filter 90 is easily clamped by the two upright plates. Even if the engine oil filter has a larger diameter, it is easily to be clamped.

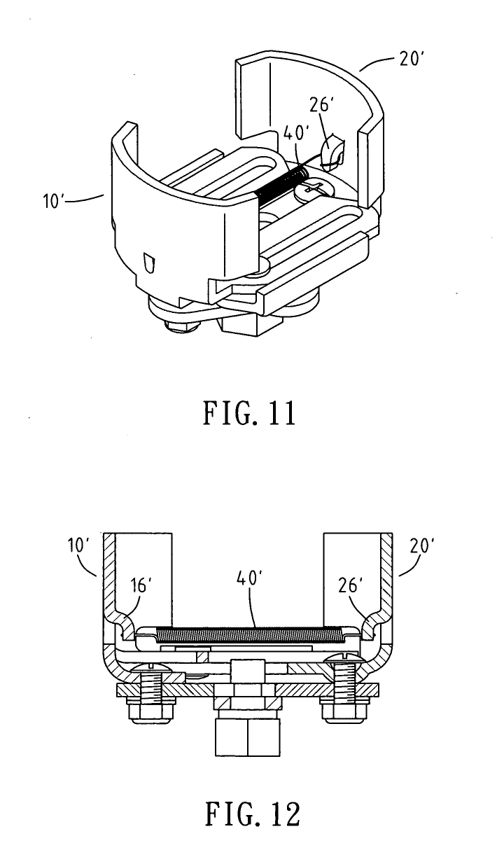

FIGS. 11 and 12 show another embodiment of the present invention, wherein each of the upright plates of the first and second clamp members 10′, 20′ has a hook 16′, 26′ extending from a center portion of an inside thereof and a spring 40′ has two ends thereof hooked with the two hooks 16′, 26′. It is noted that the spring 40′ is located at a lower position so that it does not interrupt the insertion of the engine oil filter.

While we have shown and described the embodiment in accordance with the present invention, it should be clear to those skilled in the art that further embodiments may be made without departing from the scope of the present invention.

What is claimed is:

1. A tool for removing engine oil filter, comprising:
a base having a base plate and a driving head which is located at a center of an underside of the base plate;
a first link having a first end pivotably connected to a first end of the base plate, a second link having a first end pivotably connected to a second end of the base plate, and
a first clamp member having an upright plate and two first extensions extending from the first clamp member, a second end of the first link pivotably connected to the first clamp member, a second clamp member having an upright plate and two second extensions extending from the second clamp member, a second end of the second link pivotably connected to the second clamp member, the first extensions being movable linearly relative to the second extensions so that the first and second clamp members are moved toward or away from each other.

2. The tool as claimed in claim 1, wherein the two first extensions are parallel to each other and extend from a lower end of the first clamp member, the two second extensions are parallel to each other and extend from a lower end of the second clamp member.

3. The tool as claimed in claim 2, wherein the first extensions each have an elongate slots and two pins extend through the two elongate slots and are connected to the two second extensions.

4. The tool as claimed in claim 2, wherein each of the second extensions has a guide wall extending from a side thereof and two respective sides of the two first extensions are slidable along the two guide walls.

5. The tool as claimed in claim 1, wherein the driving head has a polygonal outer periphery.

6. The tool as claimed in claim 1, wherein the driving head has an engaging recess defined in an end surface thereof.

7. The tool as claimed in claim 1, wherein a spring is connected between the two respective upright plates of the first and second clamp members.

8. The tool as claimed in claim 7, wherein each of the upright plates of the first and second clamp members has a hook extending from a center portion of an inside thereof and the spring is connected between the two hooks.
